(19) United States
(12) Patent Application Publication
(10) Pub. No.: US 2026/0328944 A1
(43) Pub. Date: Oct. 22, 2026

(54) FLASH LIDAR DEVICE

(71) Applicant: BUTZ INC., Daejeon (KR)

(72) Inventor: Yong Hyun YEUN, Daejeon (KR)

(21) Appl. No.: 19/122,966

(22) PCT Filed: Oct. 16, 2023
(86) PCT No.: PCT/KR2023/015939

§ 371 Date: Apr. 21, 2025

(30) Foreign Application Priority Data
Oct. 26, 2022 (KR) 10-2022-0139238

(51) Int. Cl. G01S 17/894; G01S 7/481; G02B 5/10; G02B 27/14; G02B 27/30

(52) U.S. Cl. CPC G01S 17/894; G01S 7/4811; G02B 5/10; G02B 27/141; G02B 27/30

(57) ABSTRACT

A flash lidar device according to the present disclosure comprises: a lateral light-emitting part for emitting light of predetermined wavelength band to a lateral side of the flash lidar device; a receiving mirror for downwardly reflecting the light reflected by a reflector located on the lateral side of the flash lidar device; a reflective mirror located below the receiving mirror to upwardly reflect the light reflected downwardly by the receiving mirror; and a distance image acquisition part located above the receiving mirror. According to the present disclosure, it is possible to detect a reflector located on the side of a flash lidar device, and since the receiving mirror has a light-transmitting part of the receiving mirror provided therein, there is no need to provide a separate path for the light reflected upward by the reflective mirror, thereby enabling size reduction of the flash lidar device.

### CROSS REFERENCE TO RELATED APPLICATIONS

The present application is a U.S. National Phase of International Application No. PCT/KR2023/015939 entitled “FLASH LIDAR DEVICE,” and filed on Oct. 16, 2023. International Application No. PCT/KR2023/015939 claims priority to Republic of Korea Patent Application No. 10-2022-0139238 filed on Oct. 26, 2022. The entire contents of each of the above-listed applications are hereby incorporated by reference for all purposes.

### TECHNICAL FIELD

The present disclosure relates to a flash lidar device that detects an external reflector using light emitted from a light-emitting part.

### BACKGROUND ART

Light detection and ranging (LIDAR) is similar to radio detection and ranging (RADAR) in terms of a function, but is different from the RADAR using a radio wave in that it uses the light. For this reason, the LIDAR is also called ‘image RADAR’.

As a lidar device, an airborne lidar device that is equipped in a satellite or an aircraft to emit light and receive light scattered by particles in the atmosphere at ground observatories has been mainly used. The airborne lidar device has been used to measure existence and movement of dust, smoke, aerosol, cloud particles, and the like, together with wind information and analyze distribution of dust particles in the atmosphere or a degree of air pollution. Recently, however, research on a ground-based lidar device that performs various functions, such as obstacle detection, terrain modeling, and reflector location acquisition, by using both the transmitting and receiving optical systems arranged on the ground is actively being conducted.

The lidar device usually includes a transmitting optical system that emits light to the outside, a receiving optical system that receives light reflected by an external reflector, and an analysis unit that calculates a distance from the lidar device to the reflector. Here, the analysis unit calculates a distance from the lidar device to the reflector based on a time difference required for the receiving optical system to receive the light emitted from the transmitting optical system, and further calculates distance in each direction using light received from various directions, thereby creating a distance map corresponding to a field of view (FOV).

Among the conventional lidar devices, there are scan type lidar devices and flash lidar devices.

Among the scan type lidar devices, a 2D scan type lidar device includes a single laser and a single receiving element, and typically acquires an image in a two-dimensional plane including a traveling direction of light by using a method of rotating a receiving mirror. In addition, among the scan type lidar devices, a 3D scan type lidar device includes a plurality of lasers and a plurality of receiving elements, and acquires an image in a three-dimensional space including a traveling direction of light by using a method of rotating a receiving mirror. Since the scan type lidar device uses a method of rotating a receiving mirror, a motor for rotating the receiving mirror should be equipped in the lidar device. In addition, since the scan type lidar device scans light in a pulse form and emits light according to the scan toward an external reflector, a range of light is relatively long, but there is a problem in that the resolution is somewhat low.

In contrast, the flash lidar device generally emits light with a wide beam width and calculates a distance from the lidar device to the reflector by a method of obtaining light reflected by an external reflector. In order to implement the flash lidar device, a light source with very high power consumption is required, and the structures of the transmitting and receiving optical systems are relatively complex in order to transmit light in plurality of directions and at the same time, receive light from plurality of directions.

Recently, attempts have been made to mount lidar devices on drones for various purposes such as reconnaissance, surveillance, and product delivery. In order for the drone equipped with the lidar device to stably perform a given mission, it should be able to detect the reflector located on the lateral side of the lidar device, and furthermore, it should be able to detect the reflector located below the lidar device for landing or charging the drone. In addition, in order for the drone equipped with the lidar device to perform a mission for a long time, the drone should be able to fly for a long time under the same power conditions. To this end, the lidar device needs to be miniaturized first.
Related Art Document: KR 10-2209500 B1 (2021 Jan. 25.)

### DISCLOSURE

### Technical Problem

The present disclosure provides a flash lidar device capable of detecting a reflector located on a lateral side of the flash lidar device and capable of being miniaturized.

In addition, the present disclosure provides a flash lidar device capable of simultaneously detecting a reflector located on a lateral side of the flash lidar device and a reflector located below the flash lidar device and capable of being miniaturized.

However, the technical problem to be solved by the present disclosure is not limited to the above-described problem, and other problems not described can be clearly understood by those skilled in the art from the description of the present disclosure described below.

### Technical Solution

In one general aspect, a flash lidar device includes: a lateral light-emitting part that emits light of a predetermined wavelength band to a lateral side of the flash lidar device; a receiving mirror that downwardly reflects light reflected by a reflector located on the lateral side of the flash lidar device; a reflective mirror that is located below the receiving mirror to upwardly reflect the light reflected downwardly by the receiving mirror; and a distance image acquisition part that is located above the receiving mirror, in which a light-transmitting part of the receiving mirror is provided on the receiving mirror, the light reflected upward by the reflective mirror transmits through the light-transmitting part of the receiving mirror, and the distance image acquisition part is located above the receiving mirror, and detects the light of the predetermined wavelength band among the light reflected upward by the reflective mirror and then transmitting through the light-transmitting part of the receiving mirror to acquire an image based on a distance to the reflector located on the lateral side of the flash lidar device.

The flash lidar device may further include a first mirror that is located above the receiving mirror, and reflects the light of the predetermined wavelength band and transmits light other than the predetermined wavelength band among the light that is reflected upward by the reflective mirror and then transmits through the light-transmitting part of the receiving mirror, in which the light of the predetermined wavelength band reflected by the first mirror may be transmitted to the distance image acquisition part.

The flash lidar device may further include a shape image acquisition part that is located above the receiving mirror, and detects light outside the predetermined wavelength band among the light reflected upward by the reflective mirror and then transmitting through the light-transmitting part of the receiving mirror to acquire an image based on a shape of the reflector located on the lateral side of the flash lidar device.

The flash lidar device may further include a second mirror that is located above the receiving mirror, and transmits the light of the predetermined wavelength band and reflects light other than the predetermined wavelength band among the light that is reflected upward by the reflective mirror and then transmits through the light-transmitting part of the receiving mirror, in which the light outside the predetermined wavelength band reflected by the second mirror may be transmitted to the shape image acquisition part.

The lateral light-emitting part may include a plurality of lateral light-emitting elements that emit the light of the predetermined wavelength band to the lateral side of the flash lidar device, and the plurality of lateral light-emitting elements may be arranged along an outer circumference of the receiving mirror.

The flash lidar device may further include a downward light-emitting part that emits the light of the predetermined wavelength band downwardly of the flash lidar device, in which the reflective mirror may be provided with a light-transmitting part of reflective mirror, the light reflected by the reflector located below the flash lidar device may transmit through the light-transmitting part of the reflective mirror and the light-transmitting part of the receiving mirror, and the distance image acquisition part may additionally detect the light of the predetermined wavelength band among the light that is reflected by the reflector located below the flash lidar device and then transmits through the light-transmitting part of the reflective mirror and the light-transmitting part of the receiving mirror to acquire an image based on a distance to the reflector located below the flash lidar device.

The flash lidar device may further include a shape image acquisition part that additionally detects light outside the predetermined wavelength band among the light that is reflected by the reflector located below the flash lidar device and transmits through the light-transmitting part of the reflective mirror and the light-transmitting part of the receiving mirror to acquire an image based on a shape of the reflector located below the flash lidar device.

The downward light-emitting part may be located at a certain distance from the receiving mirror to the lateral side, and the light of the predetermined wavelength band emitted from the downward light-emitting part may directly travel downwardly of the flash lidar device without being incident on the receiving mirror and the reflective mirror.

The lateral light-emitting part may include: a light-emitting element that emits the light of the predetermined wavelength band downwardly of the flash lidar device; and a path conversion mirror that reflects the predetermined wavelength band emitted from the light-emitting element and converts the light of the predetermined wavelength band path to the lateral side of the flash lidar device.

The path conversion mirror may be provided with a concave reflection surface, and the light of the predetermined wavelength band emitted from the light-emitting element may be incident on the concave reflection surface of the path conversion mirror.

The lateral light-emitting part may further include a lateral angle of a view adjustment lens that changes a field of view of the light of the predetermined wavelength band whose path is converted by the path conversion mirror.

The lateral light-emitting part may further include a lateral collimating lens that converts the light of the predetermined wavelength band emitted downwardly from the light-emitting element into parallel light, and the light of the predetermined wavelength band converted into the parallel light by the lateral collimating lens may be incident on the lateral field of view adjustment lens.

The downward light-emitting part may be located above the receiving mirror, and the light of the predetermined wavelength band emitted from the downward light-emitting part may directly travel downwardly of the flash lidar device and transmit through the light-transmitting part of the receiving mirror and the light-transmitting part of the reflective mirror.

The flash lidar device may further include a downward field of view adjustment lens that changes a field of view of the light of the predetermined wavelength band emitted downwardly from the downward light-emitting part.

The downward field of view adjustment lens may be arranged within the light-transmitting part of the reflective mirror or on a lower side of the light-transmitting part of the reflective mirror.

The downward light-emitting part may include: a downward light-emitting element that emits the light of the predetermined wavelength band downwardly of the flash lidar device; and a downward collimating lens that converts the light of the predetermined wavelength band emitted downwardly from the downward light-emitting element into parallel light, and the light of the predetermined wavelength band converted into the parallel light by downward collimating lens may be incident on the downward field of view adjustment lens.

### Advantageous Effects

According to the present disclosure, it is possible to detect a reflector located on a lateral side of a flash lidar device through a receiving mirror that downwardly reflects light reflected by the reflector located on the lateral side of the flash lidar device, and a reflective mirror that upwardly reflects light reflected downwardly by the receiving mirror. Furthermore, according to the present disclosure, since a light-transmitting part of the receiving mirror is provided on the receiving mirror, the light reflected upwardly by the reflective mirror may transmit through the light-transmitting part of the receiving mirror to be transmitted to an image acquisition unit. According to the present disclosure, there is no need to separately provide a path for the light reflected upwardly by the reflective mirror, so it is possible to minimize the flash lidar device.

In addition, according to the present disclosure, it is possible to simultaneously detect the reflector located on the lateral side of the flash lidar device and the reflector located downwardly through the receiving mirror provided with the light-transmitting part of the receiving mirror and the reflective mirror provided with the light-transmitting part of the reflective mirror. Furthermore, according to the present disclosure, since the light-transmitting part of the reflective mirror is provided on the reflective mirror, the light reflected by the reflector located downwardly of the flash lidar device can pass through the light-transmitting part of the reflective mirror and the light-transmitting part of the receiving mirror sequentially to be transmitted to the image acquisition unit. According to the present disclosure, there is no need to separately provide the path for the light reflected by the reflector located below the flash lidar device, so it is possible to minimize the flash lidar device.

### BRIEF DESCRIPTION OF THE DRAWINGS

FIG. 1 is a schematic diagram of a flash lidar device according to a first embodiment of the present disclosure.

FIG. 2 is a plan view of a light-emitting part support and a receiving mirror of FIG. 1, and a diagram illustrating a state in which a lateral light-emitting part of FIG. 1 emits light of a predetermined wavelength band to a lateral side of the flash lidar device.

FIG. 3 is a diagram illustrating a state in which the lateral light-emitting part of FIG. 2 emits the light of the predetermined wavelength band to the lateral side of the flash lidar device, and external light enters the flash lidar device.

FIG. 4 is a diagram illustrating a state in which a downward light-emitting part of FIG. 1 emits the light of the predetermined wavelength band to a downward side of the flash lidar device, and the external light enters the flash lidar device.

FIG. 5A is an exemplary diagram illustrating a distance-based image acquired by a distance image acquisition part of the flash lidar device illustrated in FIG. 1.

FIG. 5B is a diagram illustrating a shape-based image acquired by a shape image acquisition part of the flash lidar device illustrated in FIG. 1.

FIG. 6 is a schematic diagram of a flash lidar device according to a second embodiment of the present disclosure.

FIG. 7 is a diagram illustrating a state in which a lateral light-emitting part of FIG. 6 emits light of a predetermined wavelength band to a lateral side of the flash lidar device, and external light enters the flash lidar device.

FIG. 8 is a diagram illustrating a state in which a downward light-emitting part of FIG. 6 emits the light of the predetermined wavelength band to a downward side of the flash lidar device, and the external light enters the flash lidar device.

FIG. 9 is a diagram illustrating a downward field of view adjustment lens of FIG. 6 arranged below a light-transmitting part of a reflective mirror.

FIG. 10 is a diagram illustrating a state in which the lateral field of view adjustment lens and a lateral collimating lens are added to the flash lidar device illustrated in FIG. 6.

FIG. 11 is a diagram illustrating a state in which the lateral light-emitting part of FIG. 10 emits the light of the predetermined wavelength band to the lateral side of the flash lidar device, and the external light enters the flash lidar device.

### BEST MODE

Hereinafter, a flash lidar device according to the present disclosure will be described in detail with reference to the accompanying drawings. The accompanying drawings are provided by way of example in order to sufficiently transfer the spirit of the present disclosure to those skilled in the art, and the present disclosure is not limited to the accompanying drawing provided below, but may be implemented in another form. In this specification, ‘directly traveling’ means going straight without being reflected by any component existing on a traveling path. In addition, in this specification, external light is light reflected by a reflector 10 located outside a flash lidar device 1000, and includes light of a predetermined wavelength band and light outside the predetermined wavelength band.

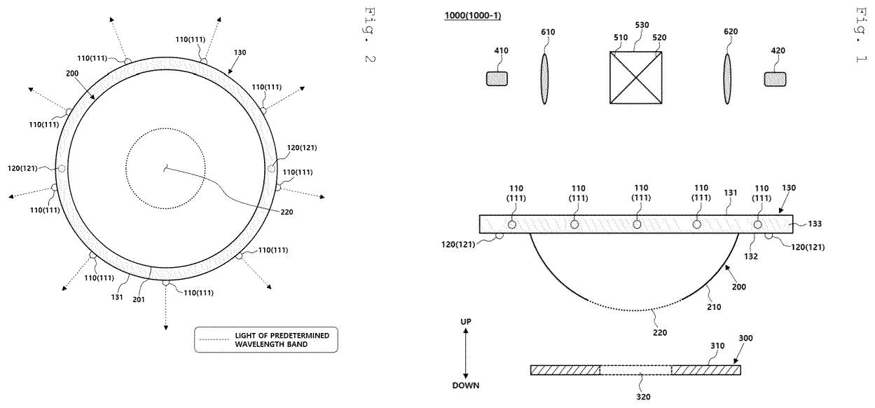

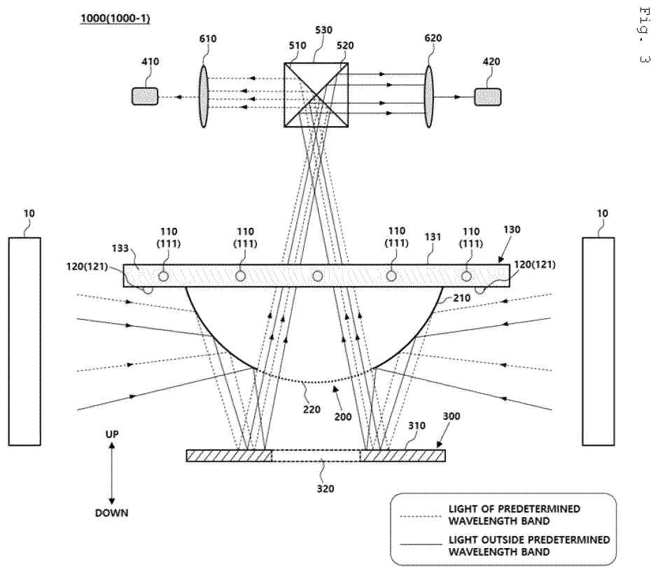

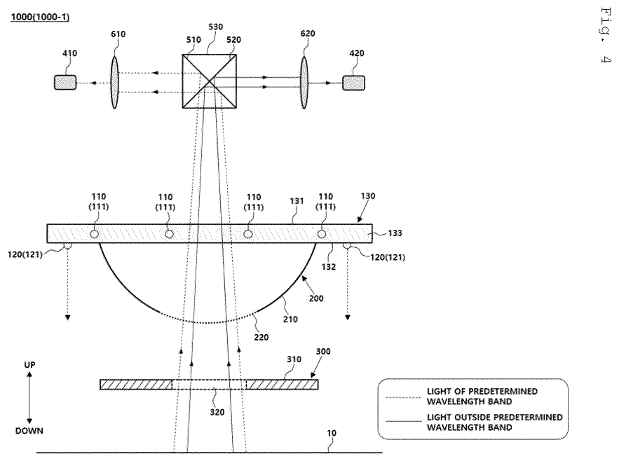

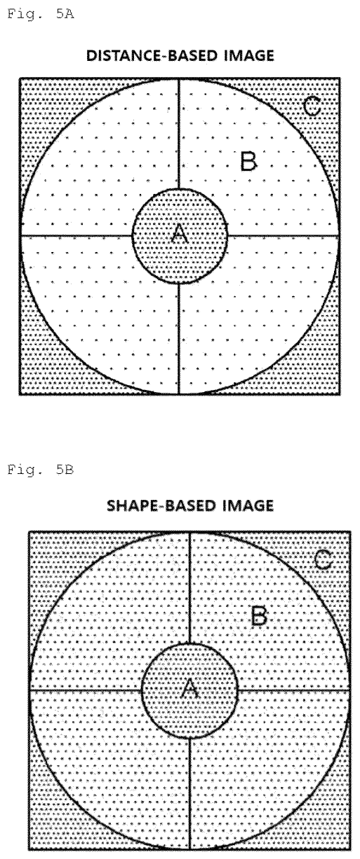

FIG. 1 is a schematic diagram of the flash lidar device 1000 (1000-1) according to a first embodiment of the present disclosure. FIG. 2 is a plan view of a light-emitting part support 130 and a receiving mirror 200 of FIG. 1, and a diagram illustrating a state in which a lateral light-emitting part 110 of FIG. 1 emits the light of the predetermined wavelength band to a lateral side of the flash lidar device 1000-1. FIG. 3 is a diagram illustrating a state in which the external light enters the flash lidar device 1000-1 as a result of the lateral light-emitting part 110 of FIG. 2 emitting the light of the predetermined wavelength band to the lateral side of the flash lidar device 1000-1. FIG. 4 is a diagram illustrating a state in which a downward light-emitting part 120 of FIG. 1 emits the light of the predetermined wavelength band downwardly of the flash lidar device 1000-1 and the external light enters the flash lidar device 1000-1.

As illustrated in FIGS. 1 to 4, the flash lidar device 1000-1 according to the first embodiment of the present disclosure may include the lateral light-emitting part 110, the receiving mirror 200, a reflective mirror 300, and a distance image acquisition part 410.

The lateral light-emitting part 110 may be supported by the light-emitting part support 130, and as illustrated in FIG. 2, emits the light of the predetermined wavelength band (e.g., light belonging to an infrared wavelength band) to the lateral side of the flash lidar device 1000-1. In FIG. 2, the light of the predetermined wavelength band emitted by the lateral light-emitting part 110 is indicated by a single dotted line, but in reality, the lateral light-emitting part 110 emits the light of the predetermined wavelength band having a specific field of view in a three-dimensional space.

The lateral light-emitting part 110 may include only one lateral light-emitting element 111 that emits the light of the predetermined wavelength band to the lateral side of the flash lidar device 1000-1. The lateral light-emitting element 111 may be formed of a light emitting diode (LED) or a vertical-cavity surface-emitting laser (VCSEL). However, when the lateral light-emitting part 110 includes only one lateral light-emitting element 111, a detection area for the lateral side of the flash lidar device 1000-1 is bound to be relatively narrow. Therefore, it is preferable that the lateral light-emitting part 110 include a plurality of lateral light-emitting elements 111 that emit the light of the predetermined wavelength band to the lateral side of the flash lidar device 1000-1.

The light-emitting part support 130 may be arranged along an outer perimeter of the receiving mirror 200 to support the lateral light-emitting part 110.

When the lateral light-emitting part 110 includes only one lateral light-emitting element 111, the one lateral light-emitting element 111 may be arranged on a side portion 133 of the light-emitting part support 130.

When the lateral light-emitting part 110 includes the plurality of lateral light-emitting elements 111, the plurality of lateral light-emitting elements 111 may be arranged at the same angle as each other on the side portion 133 of the light-emitting part support 130. As a result of arranging the plurality of lateral light-emitting elements 111 on the side portion 133 of the light-emitting part support 130 in this way, the plurality of lateral light-emitting elements 111 are arranged along the outer perimeter of the receiving mirror 200. In FIG. 2, the number of lateral light-emitting elements 111 is illustrated as 9 (arranged 40? apart from each other), but the number may be changed without any limitations.

When the plurality of lateral light-emitting elements 111 are arranged along the outer perimeter of the receiving mirror 200, the detection area for the lateral side of the flash lidar device 1000-1 may be expanded, and the miniaturization of the flash lidar device 1000-1 may also be achieved.

The light-emitting part support 130 may be arranged in a form that at least partially covers an upper perimeter of the outer perimeter of the receiving mirror 200. More specifically, a top portion 131 of the light-emitting part support 130 may be located on the same plane as a top portion 201 of the receiving mirror 200. Alternatively, the top portion 131 of the light-emitting part support 130 may be located above or below the top portion 201 of the receiving mirror 200.

Alternatively, the light-emitting part support 130 may be located above the receiving mirror 200, but may be arranged in a form in which the top portion 201 of the receiving mirror 200 extends upwardly and covers a virtual outer perimeter of the receiving mirror 200. In this case, a bottom portion 132 of the light-emitting part support 130 may be located above the top portion 201 of the receiving mirror 200.

It is preferable that the light-emitting part support 130 and the lateral light-emitting part 110 be located lower than the distance image acquisition part 410, a shape image acquisition part 420, a first mirror 510, a second mirror 520, a mirror support 530, a first lens unit 610, and a second lens unit 620. This is to prevent the image acquisition unit 410 and 420 from decreasing the efficiency of detecting the reflector 10 by preventing the light-emitting part support 130 and the lateral light-emitting part 110 from existing in an external path for light transmitted to the distance image acquisition part 410 and the shape image acquisition part 420.

When the lateral light-emitting part 110 emits the light of the predetermined wavelength band to the lateral side of the flash lidar device 1000-1, the reflector 10 located on the lateral side of the flash lidar device 1000-1 may reflect not only the light of the predetermined wavelength band but also the light outside the predetermined wavelength band, and the light reflected by the reflector 10 enters the flash lidar device 1000-1.

The receiving mirror 200 reflects downwardly the light reflected by the reflector 10 located on the lateral side of the flash lidar device 1000-1. That is, the light reflected by the reflector 10 located on the lateral side of the flash lidar device 1000-1 is reflected downwardly by the reflecting surface 210 of the receiving mirror 200. In this case, the light (i.e., the external light) reflected by the receiving mirror 200 may include not only the light of the predetermined wavelength band (e.g., light of an infrared wavelength band) emitted by the lateral light-emitting part 110 and reflected by the reflector 10, but also the light outside the predetermined wavelength band (e.g., light of a visible wavelength band).

The receiving mirror 200 may be designed in a cone shape to reflect downwardly the light reflected by the reflector 10 located on the lateral side of the flash lidar device 1000-1. In this case, the cone-shaped receiving mirror 200 may be symmetrical left and right with respect to its vertical central axis, and may have a shape in which an outer diameter gradually decreases from the top to the bottom. However, the receiving mirror 200 may be designed in various shapes according to the field of view of the light of the predetermined wavelength band emitted by the lateral light-emitting part 110. The reflecting surface 210 of the receiving mirror 200 may be designed to have a preset design function to reflect downwardly the light reflected by the reflector 10 located on the lateral side of the flash lidar device 1000-1. In addition, the receiving mirror 200 may be configured as a dichroic mirror in some cases.

The reflective mirror 300 is located below the receiving mirror 200 and reflects upwardly the light reflected downwardly by the receiving mirror 200. That is, the light reflected downwardly by the receiving mirror 200 is reflected upwardly by the reflecting surface 310 of the reflective mirror 300. The reason why the reflective mirror 300 reflects upwardly the light is to allow the light reflected by the reflector 10 located on the lateral side of the flash lidar device 1000-1 to be detected above the receiving mirror 200.

It is preferable that the reflective mirror 300 is designed in a flat shape to reflect upwardly the light reflected downwardly by the receiving mirror 200. However, the reflective mirror 300 may be designed in various shapes, in addition to a planar shape, depending on the field of view of the light of the predetermined wavelength band emitted by the lateral light-emitting part 110 or the design function of the reflecting surface 210 of the receiving mirror 200. In addition, the receiving mirror 300 may be configured as the dichroic mirror in some cases.

The receiving mirror 200 may be provided with the light-transmitting part of the receiving mirror 220. The reason why the light-transmitting part of the receiving mirror 220 is provided in the receiving mirror 200 is to allow the light reflected by the reflector 10 located on the lateral side of and below the flash lidar device 1000-1 to transmit through the light-transmitting part of the receiving mirror 220, thereby allowing the light to be detected on an upper side of the receiving mirror 200.

The light-transmitting part of the receiving mirror 220 may be provided at approximately the center of the receiving mirror 200, and may be a through hole penetrating through the receiving mirror 200. Alternatively, the light-transmitting part of the receiving mirror 220 may be a portion of glass that is not mirror-coated, unlike the reflecting surface 210 that is mirror-coated.

The light reflected upwardly by the reflective mirror 300 transmits through the light-transmitting part of the receiving mirror 220 and travels to the upper side of the receiving mirror 200.

A first mirror 510 and a second mirror 520 supported by a mirror support 530 may be located on the upper side of the receiving mirror 200.

The first mirror 510 is located above the receiving mirror 200, and serves to reflect the light of the predetermined wavelength band and transmit the light outside the predetermined wavelength band, among the light that is reflected upwardly by the reflective mirror 300 and then transmits through the light-transmitting part of the receiving mirror 220. To this end, the first mirror 510 may be configured as a dichroic mirror or an integrated dichroic prism.

The second mirror 520 is located above the receiving mirror 200, and serves to transmit through the light of the predetermined wavelength band and reflect the light outside the predetermined wavelength band, among the light that is reflected upwardly by the reflective mirror 300 and then transmits through the light-transmitting part of the receiving mirror 220. To this end, the second mirror 510 may be configured as the dichroic mirror or the integrated dichroic prism.

As illustrated in FIG. 1 or the like, the first mirror 510 and the second mirror 520 may be arranged in an intersecting manner, but unlike this, the first mirror 510 and the second mirror 520 may be arranged in a manner such that they do not intersect each other by being located at different locations in the vertical direction.

The light of predetermined wavelength band reflected by the first mirror 510 is transmitted to the distance image acquisition part 410, and the light outside the predetermined wavelength band reflected by the second mirror 520 is transmitted to the shape image acquisition part 420.

The first lens unit 610 is arranged between the first mirror 510 and the distance image acquisition part 410, and functions to focus the light of the predetermined wavelength band reflected by the first mirror 510 and transmit the focused light to the distance image acquisition part 410. In addition, the second lens part 620 is arranged between the second mirror 520 and the shape image acquisition part 420, and functions to focus the light outside predetermined wavelength band reflected by the second mirror 520 and transmit the focused light to the shape image acquisition part 420.

The distance image acquisition part 410 is located above the receiving mirror 200, and detects the light of the predetermined wavelength band among the light that is reflected upwardly by the reflective mirror 300 and then transmits through the light-transmitting part of the receiving mirror 220, thereby acquiring the image based on the distance to the reflector 10 located on the lateral side of the flash lidar device 1000-1. The distance image acquisition part 410 may be formed of a 2D time of flight (TOF) sensor for distance measurement, or may be formed of a form in which a single light receiving element (e.g., a photodiode, an avalanche photodiode, etc.) is arranged in two dimensions. The distance image acquisition part 410 may determine the distance from the flash lidar device 1000-1 to the reflector 10 located on the lateral side through the image based on the distance to the reflector 10 located on the lateral side.

The shape image acquisition part 420 is located above the receiving mirror 200, and detects the light outside the predetermined wavelength band among the light that is reflected upwardly by the reflective mirror 300 and then transmits through the light-transmitting part of the receiving mirror 220, thereby acquiring the image based on the shape of the reflector 10 located on the lateral side of the flash lidar device 1000-1. The shape image acquisition part 420 may be formed of an image sensor (e.g., CCD, RGB-IR, etc.), and may determine the shape of the reflector 10 located on the lateral side through the image based on the shape of the reflector 10 located on the lateral side.

Meanwhile, the flash lidar device 1000-1 according to the first embodiment of the present disclosure may additionally include the downward light-emitting part 120. The downward light-emitting part 120 may be supported by the light-emitting part support 130 and, as illustrated in FIG. 4, emits the light of the predetermined wavelength band downwardly from the flash lidar device 1000-1.

The wavelength band of light emitted by the downward light-emitting part 120 may be the same as the wavelength band of light emitted by the lateral light-emitting part 110. In FIG. 4, the light of the predetermined wavelength band emitted by the downward light-emitting part 120 is indicated by a single dotted line, but in reality, the downward light-emitting part 120 emits the light of the predetermined wavelength band having a specific field of view in a three-dimensional space.

According to the first embodiment of the present disclosure, the downward light-emitting part 120 is located at a predetermined distance from the receiving mirror 200 on the lateral side, and the light of the predetermined wavelength band emitted from the downward light-emitting part 120 directly travels downwardly toward the flash lidar device 1000-1 without being incident on the receiving mirror 200 and the reflective mirror 300. In this case, since there is no or very little possibility that the light of the predetermined wavelength band emitted from the downward light-emitting part 120 will be incident on the inner surface of the receiving mirror 200, it is possible to prevent the decrease in the efficiency of the image acquisition unit 410 and 420 detecting the reflector 10 located downwardly toward the flash lidar device 1000-1.

The downward light-emitting part 120 may include only one downward light-emitting element 121 that emits the light of the predetermined wavelength band downwardly of the flash lidar device 1000-1, and the downward light-emitting element 121 may be formed of the LED or VCSEL. However, when the downward light-emitting part 120 includes only one downward light-emitting element 121, the detection area for the lower side of the flash lidar device 1000-1 is bound to be relatively narrow. Therefore, it is preferable that the downward light-emitting part 120 include the plurality of downward light-emitting elements 121 that emit the light of the predetermined wavelength band downwardly of the flash lidar device 1000-1.

When the downward light-emitting part 120 includes only one downward light-emitting element 121, the one downward light-emitting element 121 may be arranged on the bottom portion 132 of the light-emitting part support 130.

When the downward light-emitting part 120 includes the plurality of downward light-emitting elements 121, the plurality of downward light-emitting elements 121 may be arranged at the same angle as each other on the bottom portion 132 of the light-emitting part support 130. As a result of arranging the plurality of downward light-emitting elements 121 on the bottom portion 132 of the light-emitting part support 130 in this way, the plurality of downward light-emitting elements 121 are arranged along the outer perimeter of the receiving mirror 200. In FIG. 2, the number of downward light-emitting elements 121 is illustrated as 2 (arranged 180? apart from each other), but the number may be changed without any limitations.

The downward light-emitting part 120 may be located below or above the top portion 201 of the receiving mirror 200, or may be located on the same surface as the top portion 201 of the receiving mirror 200 as needed.

The light of the predetermined wavelength band emitted from the downward light-emitting part 120 directly travels downwardly from the flash lidar device 1000-1, and when the reflector 10 exists downwardly from the flash lidar device 1000-1 as illustrated in the ground in FIG. 4, the reflector 10 reflects the light of the predetermined wavelength band upwardly.

A light-transmitting part 320 of a reflective mirror may be provided in the reflective mirror 300. The reason why the light-transmitting part 320 of the reflective mirror is provided on the reflective mirror 300 is to allow the light reflected upwardly by the reflector 10 located below the flash lidar device 1000-1 to transmit through the light-transmitting part 320 of the reflective mirror, thereby allowing the light to be detected on the upper side of the receiving mirror 200.

The light-transmitting part 320 of the reflective mirror may be provided at approximately the center of the reflective mirror 300, and may be the through hole penetrating through the reflective mirror 300. Alternatively, the light-transmitting part 320 of the reflective mirror may be a portion of glass that is not mirror-coated, unlike the reflecting surface 310 that is mirror-coated.

The light reflected upwardly by the reflector 10 located below the flash lidar device 1000-1 sequentially transmits through the light-transmitting part 320 of the reflective mirror and the light-transmitting part of the receiving mirror 220 and travels to the upper side of the receiving mirror 200.

In this case, the first mirror 510 serves to reflect the light of the predetermined wavelength band and transmit the light outside the predetermined wavelength band among the light that is reflected upwardly by the reflector 10 located below the flash lidar device 1000-1 and then sequentially transmits through the light-transmitting part 320 of the reflective mirror and the light-transmitting part of the receiving mirror 220.

In addition, the second mirror 520 serves to transmit the light of the predetermined wavelength band and reflect the light outside the predetermined wavelength band among the light that is reflected upwardly by the reflector 10 located below the flash lidar device 1000-1 and then sequentially transmits through the light-transmitting part 320 of the reflective mirror and the light-transmitting part of the receiving mirror 220.

The light of the predetermined wavelength band reflected by the first mirror 510 may be focused by the first lens unit 610 and then transmitted to the distance image acquisition part 410, and the light outside the predetermined wavelength band reflected by the second mirror 520 may be focused by the second lens unit 620 and then transmitted to the shape image acquisition part 420.

The distance image acquisition part 410 additionally detects the light of the predetermined wavelength band among the light that is reflected upwardly by the reflector 10 located below the flash lidar device 1000-1 and sequentially transmits through the light-transmitting part 320 of the reflective mirror and the light-transmitting part of the receiving mirror 220, thereby acquiring the image based on the distance to the reflector 10 located below the flash lidar device 1000-1. In this case, the distance image acquisition part 410 may determine the distance from the flash lidar device 1000-1 to the reflector 10 located below the flash lidar device 1000-1 through the image based on the distance to the reflector 10 located below the flash lidar device 1000-1.

The shape image acquisition part 420 additionally detects the light outside the predetermined wavelength band among the light that is reflected upwardly by the reflector 10 located below the flash lidar device 1000-1 and sequentially transmits through the light-transmitting part 320 of the reflective mirror and the light-transmitting part of the receiving mirror 220, thereby acquiring the image based on the shape of the reflector 10 located below the flash lidar device 1000-1. In this case, the shape image acquisition part 420 may identify the shape of the reflector 10 located below through the image based on the shape of the reflector 10 located below the flash lidar device 1000-1.

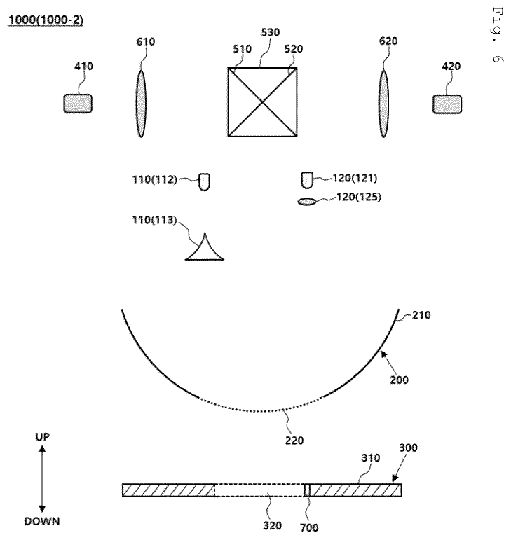

FIG. 5A is a diagram illustrating the distance-based image acquired by the distance image acquisition part 410 of the flash lidar device 1000-1 illustrated in FIG. 1.

Specifically, area “A” of FIG. 5A is an area where an image is acquired based on the distance to the reflector 10 located below the flash lidar device 1000-1, area “B” is an area where an image is acquired based on the distance to the reflector 10 located on the lateral side of the flash lidar device 1000-1, and area “C” is an area where no image is acquired because it is outside the field of view of the light-emitting parts 110 and 120. Referring to FIG. 5A, it may be seen that the distance to the reflector 10 located below and the lateral side of the flash lidar device 1000-1 may be detected simultaneously with only one distance image acquisition part 410.

FIG. 5B is a diagram illustrating the shape-based image acquired by the shape image acquisition part 420 of the flash lidar device 1000-1 illustrated in FIG. 1.

Specifically, area “A” of FIG. 5B is an area where an image is acquired based on the shape of the reflector 10 located below the flash lidar device 1000-1, area “B” is an area where an image is acquired based on the shape of the reflector 10 located on the lateral side of the flash lidar device 1000-1, and area “C” is an area where no image is acquired because it is outside the field of view of the light-emitting parts 110 and 120. Referring to FIG. 5B, it may be seen that the shape of the reflector 10 located on the lateral side of and below the flash lidar device 1000-1 may be detected simultaneously with only one shape image acquisition part 420.

In this way, according to the flash lidar device 1000-1 according to the first embodiment of the present disclosure, since it is possible to simultaneously detect the image based on the distance to the reflector 10 and the image based on the shape of the reflector 10, it is possible to utilize the simultaneously detected images for 3D modeling based on a real image.

Furthermore, since the area “A” of FIG. 5A and the area “A” of FIG. 5B correspond to the area where light is transmitted in the conventional lidar device, these areas As correspond to shaded areas where no image may be acquired by the image acquisition unit 410 and 420. In contrast, the flash lidar device 1000-1 according to the present disclosure includes components such as the receiving mirror 200 provided with the light-transmitting part of the receiving mirror 220 and the reflective mirror 300 provided with the light-transmitting part of a reflective mirror 320, so the “A” area of FIG. 5A is utilized as an image acquisition area based on the distance of the reflector 10 located below the flash lidar device 1000-1, and the “A” area of FIG. 5b is utilized as an image acquisition area based on the shape of the reflector 10 located below the flash lidar device 1000-1.

According to the present disclosure, in order to simultaneously detect the distance to the reflector 10 located on the lateral side of and below the flash lidar device 1000-1, only one distance image acquisition part 410 is sufficient, and in order to simultaneously detect the shape of the reflector 10 located on the lateral side of and below the flash lidar device 1000-1, only one shape image acquisition part 420 is sufficient. Therefore, according to the present disclosure, it is possible to miniaturize the flash lidar device 1000-1, and reduce the manufacturing cost of the device.

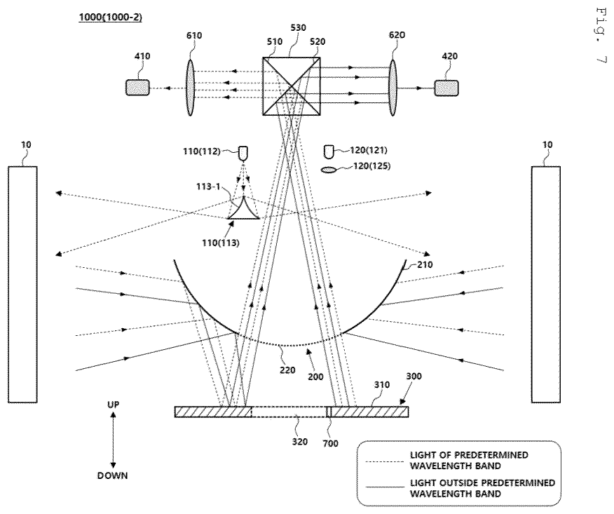

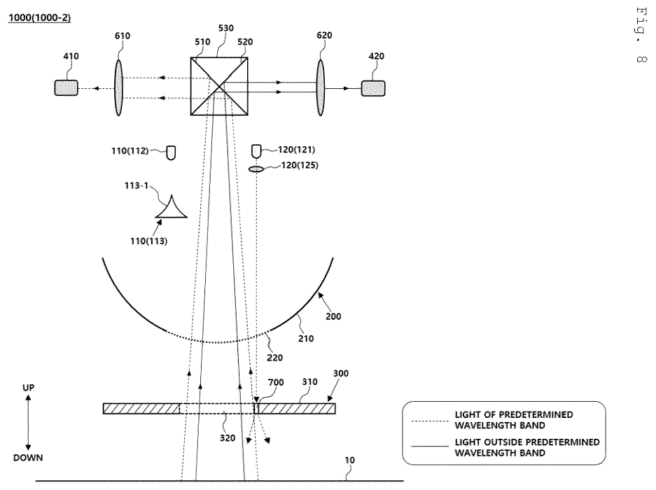

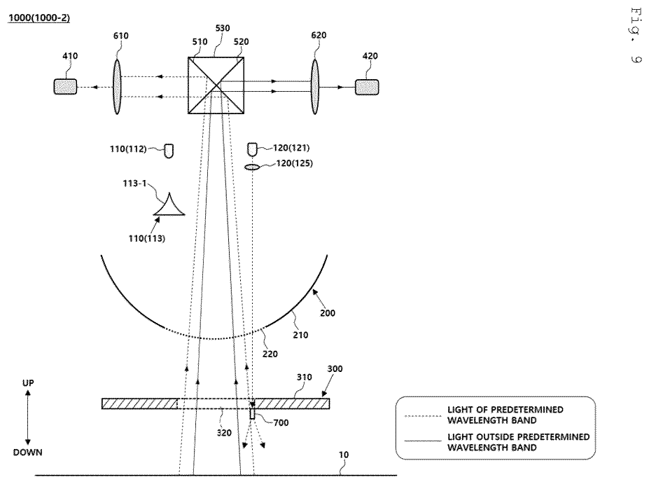

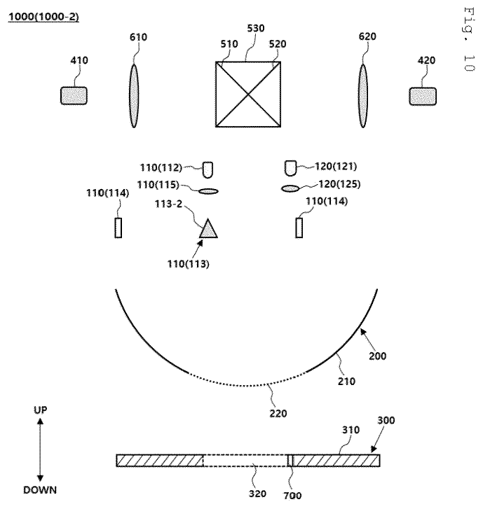

FIG. 6 is a schematic diagram of a flash lidar device 1000 (1000-2) according to a second embodiment of the present disclosure. FIG. 7 is a diagram illustrating a state in which the lateral light-emitting part 110 of FIG. 6 emits the light of the predetermined wavelength band toward the lateral side of the flash lidar device 1000-2 and the external light enters the flash lidar device 1000-2. FIG. 8 is a diagram illustrating a state in which a downward light-emitting part 120 of FIG. 6 emits the light of the predetermined wavelength band downwardly of the flash lidar device 1000-2 and the external light enters the flash lidar device 1000-2. FIG. 9 is a diagram illustrating a downward field of view adjustment lens 700 of FIG. 6 arranged below the light-transmitting part 320 of the reflective mirror.

The flash lidar device 1000-2 according to the second embodiment of the present disclosure differs from the flash lidar device 1000-1 according to the first embodiment only in that the detailed components of the lateral light-emitting part 110 and the detailed components of the downward light-emitting part 120 are different, and the downward field of view adjustment lens 700 is added. Therefore, the following description will focus on the parts where the differences are present.

The lateral light-emitting part 110 according to the second embodiment of the present disclosure may include a light-emitting element 112 and a path conversion mirror 113.

The light-emitting element 112 emits the light of the predetermined wavelength band downwardly from the flash lidar device 1000-2. The path conversion mirror 113 reflects the light of the predetermined wavelength band emitted from the light-emitting element 112 and converts the light of the predetermined wavelength band path into the lateral side of the flash lidar device 1000-2.

It is preferable that the light-emitting element 112 and the path conversion mirror 113 are located in a place where there is no or very little risk of interference between the light of the predetermined wavelength band path emitted downwardly from the flash lidar device 1000-2 and the path for light entering the flash lidar device 1000-2. Accordingly, it is preferable that the light-emitting element 112 and the path conversion mirror 113 are located between the receiving mirror 200 and the image acquisition units 410 and 420 or located above the image acquisition units 410 and 420.

The light-emitting element 112 may be made of an LED or a VCSEL.

The path conversion mirror 113 may be designed in a cone shape to convert the light of the predetermined wavelength band path emitted from the light-emitting element 112 into the lateral side of the flash lidar device 1000-2. In this case, the cone-shaped path conversion mirror 113 may be symmetrical left and right based on its vertical center axis, and may have a shape in which the outer diameter gradually increases from the top to the bottom. However, the path conversion mirror 113 may be designed in various shapes other than the cone shape according to the field of view of the light of the predetermined wavelength band emitted from the light-emitting element 112.

A concave reflecting surface 113-1 may be provided on the path conversion mirror 113, and in this case, the light of the predetermined wavelength band emitted from the light-emitting element 112 is incident on the concave reflecting surface 113-1 of the path conversion mirror 113. When the concave reflecting surface 113-1 is provided on the path conversion mirror 113, the light of the predetermined wavelength band path emitted from the light-emitting element 112 is converted into the lateral side, and at the same time, the field of view of the light of the predetermined wavelength band is expanded. As a result, the detection range of the reflector 10 located on the lateral side of the flash lidar device 1000-2 may be expanded.

When the light of the predetermined wavelength band path is converted into the lateral side of the flash lidar device 1000-2 through the path conversion mirror 113 as in the second embodiment of the present disclosure, the number of light-emitting elements 112 required to detect the reflector 10 located on the lateral side of the flash lidar device 1000-2 may be significantly reduced. For example, when the path conversion mirror 113 is designed in the cone shape, the light of the predetermined wavelength band emitted from the light-emitting element 112 is path-converted into the entire horizontal range (i.e., a 360° range) by the path conversion mirror 113 and transmitted to the lateral side of the flash lidar device 1000-2. Therefore, according to the second embodiment of the present disclosure, it is not necessary to have the plurality of lateral light-emitting elements 111 arranged along the outer perimeter of the receiving mirror 200 as in the first embodiment.

In addition, since the light of the predetermined wavelength band path-converted by the path conversion mirror 113 is transmitted to the lateral side of the flash lidar device 1000-2 with a specific field of view, it is not necessary to adopt a separate component for adjusting the field of view of the light of the predetermined wavelength band transmitted to the lateral side of the flash lidar device 1000-2. Therefore, according to the present disclosure, it is possible to miniaturize the flash lidar device 1000-2, and reduce the manufacturing cost of the device.

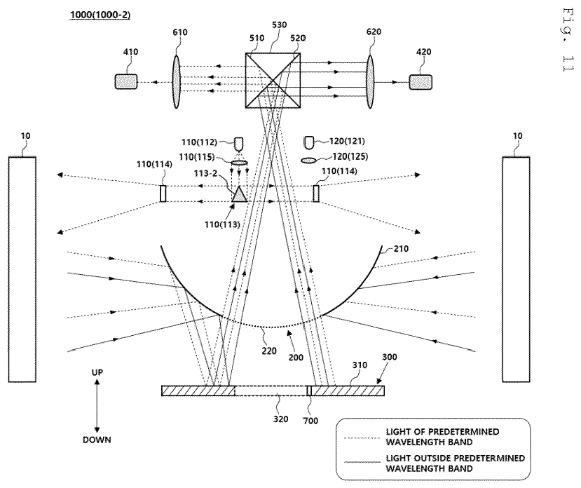

FIG. 10 is a diagram illustrating the flash lidar device 1000-2 according to FIG. 6 to which a lateral field of view adjustment lens 114 and a lateral collimating lens 115 are added. FIG. 11 is a diagram illustrating a state in which the lateral light-emitting part 110 of FIG. 10 emits the light of the predetermined wavelength band toward the lateral side of the flash lidar device 1000-2 and the external light enters the flash lidar device 1000-2.

The lateral light-emitting part 110 according to the second embodiment of the present disclosure may further include the lateral field of view adjustment lens 114 as illustrated in FIGS. 10 and 11. Here, the lateral field of view adjustment lens 114 may be formed by a convex lens, a concave lens, or a combination of the convex lens and the concave lens.

As illustrated in FIG. 11, the light of the predetermined wavelength band path-converted by the path conversion mirror 113 may be incident on the lateral field of view adjustment lens 114. In this case, a flat reflecting surface 113-2 may be provided on the path conversion mirror 113. When the flat reflecting surface 113-2 is provided on the path conversion mirror 113, the light of the predetermined wavelength band path emitted from the light-emitting element 112 is converted into the lateral side, but the field of view of the light of the predetermined wavelength band is not changed or the change is relatively small. In contrast, in the example of FIG. 11, the path conversion mirror 113 may be provided with the concave reflecting surface 113-1 as described above, and in this case, the field of view of the light of the predetermined wavelength band is expanded to a relatively large extent. The lateral field of view adjustment lens 114 changes (i.e., expands or reduces) the field of view of the light of the predetermined wavelength band path-converted by the path conversion mirror 113. For example, when the lateral field of view adjustment lens 114 expands the field of view of the light of the predetermined wavelength band path-converted by the path conversion mirror 113, the detection area for the lateral side of the flash lidar device 1000-2 may be further expanded. On the other hand, when the lateral field of view adjustment lens 114 reduces the field of view of the light of the predetermined wavelength band path-converted by the path conversion mirror 113, the reflector 10 located on the lateral side of the flash lidar device 1000-2 may be more precisely detected. In order to change the field of view of the light of the predetermined wavelength band path-converted to the entire horizontal range by the path conversion mirror 113, the plurality of lateral field of view adjustment lenses 114 may be arranged to surround the path conversion mirror 113 in a horizontal direction (i.e., a direction perpendicular to the up-down direction illustrated in FIG. 11). In this case, the plurality of lateral field of view adjustment lenses 114 may be spaced apart from each other by the same angle. Alternatively, in order to change the field of view of the light of the predetermined wavelength band that is path-converted into the entire horizontal range by the path conversion mirror 113, the lateral field of view adjustment lens 114 may be designed in a donut shape. In this case, it is preferable that the path conversion mirror 113 be located at the center of the donut-shaped lateral field of view adjustment lens 114. When the light of the predetermined wavelength band that is path-converted by the path conversion mirror 113 is incident on the donut-shaped lateral field of view adjustment lens 114, the field of view of the light of the predetermined wavelength band is changed to the entire horizontal range.

Meanwhile, when the light of the predetermined wavelength band path-converted by the path conversion mirror 113 is incident on an inner surface of the receiving mirror 200, the light of the predetermined wavelength band reflected from the inner surface of the receiving mirror 200 is transmitted to the image acquisition units 410 and 420, which may reduce the efficiency of the image acquisition units 410 and 420 detecting the reflector 10. Accordingly, it is preferable to arrange the lateral collimating lens 115 below the light-emitting element 112. The lateral collimating lens 115 converts the light of the predetermined wavelength band emitted downwardly from the light-emitting element 112 into parallel light, and accordingly, the light of the predetermined wavelength band converted into the parallel light by the lateral collimating lens 115 is incident on the lateral field of view adjustment lens 114.

According to the lateral collimating lens 115, in the process where the light of the predetermined wavelength band emitted downwardly by the light-emitting element 112 is path-converted by the path conversion mirror 113 and then transmitted to the lateral side of the flash lidar device 1000-2, the phenomenon of the light of the predetermined wavelength band being incident on the inner surface of the receiving mirror 200 may be reliably prevented. As a result, the efficiency of the image acquisition unit 410 and 420 detecting the reflector 10 may be prevented in advance.

The flash lidar device 1000-2 according to the second embodiment of the present disclosure may also additionally include the downward light-emitting part 120 that emits the light of the predetermined wavelength band downwardly from the flash lidar device 1000-2 (see FIGS. 8 and 9). Here, the downward light-emitting part 120 is located above the receiving mirror 200, and the light of the predetermined wavelength band emitted from the downward light-emitting part 120 directly travels downwardly to the flash lidar device 1000-2 and transmits through the light-transmitting part of the receiving mirror 220 and the light-transmitting part 320 of the reflective mirror.

According to the second embodiment in which the downward light-emitting part 120 is located above the receiving mirror 200, the width of the flash lidar device 1000-2 may be reduced compared to the first embodiment in which the downward light-emitting part 120 is located at a certain distance from the receiving mirror 200 on the lateral side of the flash lidar device 1000-2.

The downward light-emitting part 120 emits the light of the predetermined wavelength band having a specific field of view in a three-dimensional space. However, when the light of the predetermined wavelength band is incident on the inner surface of the receiving mirror 200 or incident on the reflecting surface 310 of the reflective mirror 300, the detection efficiency of the reflector 10 of the image acquisition unit 410 and 420 may be reduced Therefore, the field of view of the light of the predetermined wavelength band emitted downwardly by the downward light-emitting part 120 needs to be designed to be relatively narrow.

The flash lidar device 1000-2 according to the second embodiment may further include the downward field of view adjustment lens 700. Here, the downward field of view adjustment lens 700 may be formed by a convex lens, a concave lens, or a combination of the convex lens and the concave lens.

As illustrated in FIGS. 8 and 9, the light of the predetermined wavelength band emitted downwardly from the light-emitting part 120 may be incident on the downward field of view adjustment lens 700, and in this case, the downward field of view adjustment lens 700 may change (i.e., expand or reduce) the field of view of the light of the predetermined wavelength band. When the downward field of view adjustment lens 700 expands the field of view of the light of the predetermined wavelength band emitted downwardly from the light-emitting part 120, the detection area below the flash lidar device 1000-2 may be further expanded. In contrast, when the downward field of view adjustment lens 700 reduces the field of view of the light of the predetermined wavelength band emitted downwardly from the light-emitting part 120, the reflector 10 located below the flash lidar device 1000-2 may be more precisely detected.

As described above, when the light of the predetermined wavelength band emitted by the downward light-emitting part 120 is incident on the inner surface of the receiving mirror 200 or the reflecting surface 310 of the reflective mirror 300, the detection efficiency of the reflector 10 of the image acquisition unit 410 and 420 may be reduced. Therefore, it is preferable that the downward field of view adjustment lens 700 is arranged within the light-transmitting part 320 of the reflective mirror as illustrated in FIG. 8, or is arranged below the light-transmitting part 320 of the reflective mirror as illustrated in FIG. 9. Here, the downward field of view adjustment lens 700 is more preferably arranged within the light-transmitting part 320 of the reflective mirror than is arranged below the light-transmitting part 320 of the reflective mirror. This is because the downward field of view adjustment lens 700 is more advantageous in reducing the height of the flash lidar device 1000-2 when it is arranged within the light-transmitting part 320 of the reflective mirror than when it is arranged below the light-transmitting part 320 of the reflective mirror.

The downward light-emitting part 120 may include a downward light-emitting element 121 and a downward collimating lens 125.

The downward light-emitting element 121 emits the light of the predetermined wavelength band downwardly from the flash lidar device 1000-2 and may be formed of the LED or VCSEL.

Even when the field of view of the light of the predetermined wavelength band emitted downwardly from the flash lidar device 1000-2 by the downward light-emitting element 121 is designed to be relatively narrow, depending on the limitation of the field of view of the downward light-emitting element 121, the arrangement of the downward light-emitting element 121, the size of the light-transmitting part of the receiving mirror 220, or the size of the light-transmitting part 320 of the reflective mirror, the light of the predetermined wavelength band may be incident on the inner surface of the receiving mirror 200 or on the reflecting surface 310 of the reflective mirror 300. Accordingly, it is preferable to arrange the downward collimating lens 125 below the downward light-emitting element 121. The downward collimating lens 125 converts the light of the predetermined wavelength band emitted downwardly from the downward light-emitting element 121 into the parallel light, and in this case, the light of the predetermined wavelength band converted into the parallel light by the downward collimating lens 125 is incident on the downward angle of the view adjustment lens 700. According to the downward collimating lens 125, the phenomenon in which the light of the predetermined wavelength band emitted by the downward light-emitting part 120 is incident on the inner surface of the receiving mirror 200 or the reflecting surface 310 of the reflective mirror 300 may be more reliably prevented, so the reduction in the efficiency of the image acquisition unit 410 and 420 detecting the reflector 10 may be prevented in advance.

As described above, although the present disclosure has been described with limited embodiments and drawings, the present disclosure is not limited to the above embodiments, and various modifications and variations are possible from this description by those skilled in the art to which the present disclosure pertains. Therefore, the technical idea of the present disclosure should be understood only by the following claims, and all of the equivalences and equivalent modifications to the claims are intended to fall within the technical idea of the present disclosure.

### MODE FOR INVENTION

The best mode for carrying out the present disclosure as described above has been described.

### INDUSTRIAL APPLICABILITY

The present disclosure may be applied to a flash lidar device that detects an external reflector using light emitted from a light-emitting part.

1. A flash lidar device, comprising:
a lateral light-emitting part that emits light of a predetermined wavelength band to a lateral side of the flash lidar device;
a receiving mirror that downwardly reflects light reflected by a reflector located on the lateral side of the flash lidar device;
a reflective mirror that is located below the receiving mirror to upwardly reflect the light reflected downwardly by the receiving mirror; and
a distance image acquisition part that is located above the receiving mirror,
wherein a light-transmitting part of the receiving mirror is provided on the receiving mirror,
the light reflected upward by the reflective mirror transmits through the light-transmitting part of the receiving mirror, and
the distance image acquisition part is located above the receiving mirror, and detects the light of the predetermined wavelength band among the light that is reflected upward by the reflective mirror and then transmits through the light-transmitting part of the receiving mirror to acquire an image based on a distance to the reflector located on the lateral side of the flash lidar device.

2. The flash lidar device of claim 1, further comprising
a first mirror that is located above the receiving mirror, and reflects the light of the predetermined wavelength band and transmits light other than the predetermined wavelength band among the light that is reflected upward by the reflective mirror and then transmits through the light-transmitting part of the receiving mirror,
wherein the light of the predetermined wavelength band reflected by the first mirror is transmitted to the distance image acquisition part.

3. The flash lidar device of claim 1, further comprising
a shape image acquisition part that is located above the receiving mirror, and detects light outside the predetermined wavelength band among the light that is reflected upward by the reflective mirror and then transmits through the light-transmitting part of the receiving mirror to acquire an image based on a shape of the reflector located on the lateral side of the flash lidar device.

4. The flash lidar device of claim 3, further comprising
a second mirror that is located above the receiving mirror, and transmits the light of the predetermined wavelength band and reflects light other than the predetermined wavelength band among the light that is reflected upward by the reflective mirror and then transmits through the light-transmitting part of the receiving mirror,
wherein the light outside the predetermined wavelength band reflected by the second mirror is transmitted to the shape image acquisition part.

5. The flash lidar device of claim 1, wherein the lateral light-emitting part includes a plurality of lateral light-emitting elements that emit the light of the predetermined wavelength band to the lateral side of the flash lidar device, and
the plurality of lateral light-emitting elements are arranged along an outer circumference of the receiving mirror.

6. The flash lidar device of claim 1, further comprising
a downward light-emitting part that emits the light of the predetermined wavelength band downwardly of the flash lidar device,
wherein the reflective mirror is provided with a light-transmitting part of reflective mirror,
the light reflected by the reflector located below the flash lidar device transmits through the light-transmitting part of the reflective mirror and the light-transmitting part of the receiving mirror, and
the distance image acquisition part additionally detects the light of the predetermined wavelength band among the light that is reflected by the reflector located below the flash lidar device and then transmits through the light-transmitting part of the reflective mirror and the light-transmitting part of the receiving mirror to acquire an image based on a distance to the reflector located below the flash lidar device.

7. The flash lidar device of claim 6, further comprising
a shape image acquisition part that additionally detects light outside the predetermined wavelength band among the light that is reflected by the reflector located below the flash lidar device and transmits through the light-transmitting part of the reflective mirror and the light-transmitting part of the receiving mirror to acquire an image based on a shape of the reflector located below the flash lidar device.

8. The flash lidar device of claim 6, wherein the downward light-emitting part is located at a certain distance from the receiving mirror to the lateral side, and
the light of the predetermined wavelength band emitted from the downward light-emitting part directly travels downwardly of the flash lidar device without being incident on the receiving mirror and the reflective mirror.

9. The flash lidar device of claim 1, wherein the lateral light-emitting part includes:
a light-emitting element that emits the light of the predetermined wavelength band downwardly of the flash lidar device; and
a path conversion mirror that reflects the predetermined wavelength band emitted from the light-emitting element and converts the light of the predetermined wavelength band path to the lateral side of the flash lidar device.

10. The flash lidar device of claim 9, wherein the path conversion mirror is provided with a concave reflection surface, and
the light of the predetermined wavelength band emitted from the light-emitting element is incident on the concave reflection surface of the path conversion mirror.

11. The flash lidar device of claim 9, wherein the lateral light-emitting part further includes a lateral angle of a view adjustment lens that changes a field of view of the light of the predetermined wavelength band whose path is converted by the path conversion mirror.

12. The flash lidar device of claim 11, wherein the lateral light-emitting part further includes a lateral collimating lens that converts the light of the predetermined wavelength band emitted downwardly from the light-emitting element into parallel light, and
the light of the predetermined wavelength band converted into the parallel light by the lateral collimating lens is incident on the lateral field of view adjustment lens.

13. The flash lidar device of claim 6, wherein the downward light-emitting part is located above the receiving mirror, and
the light of the predetermined wavelength band emitted from the downward light-emitting part directly travels downwardly of the flash lidar device and transmits through the light-transmitting part of the receiving mirror and the light-transmitting part of the reflective mirror.

14. The flash lidar device of claim 13, further comprising a downward field of view adjustment lens that changes a field of view of the light of the predetermined wavelength band emitted downwardly from the downward light-emitting part.

15. The flash lidar device of claim 14, wherein the downward field of view adjustment lens is arranged within the light-transmitting part of the reflective mirror or on a lower side of the light-transmitting part of the reflective mirror.

16. The flash lidar device of claim 14, wherein the downward light-emitting part includes:
a downward light-emitting element that emits the light of the predetermined wavelength band downwardly of the flash lidar device; and
a downward collimating lens that converts the light of the predetermined wavelength band emitted downwardly from the downward light-emitting element into parallel light, and
the light of the predetermined wavelength band converted into the parallel light by downward collimating lens is incident on the downward field of view adjustment lens.
